(19) United States
(12) Patent Application Publication
(10) Pub. No.: US 2004/0155983 A1
(43) Pub. Date: Aug. 12, 2004

(54) Reduced artifact luminance/chrominance (Y/C) separator for use in an NTSC decoder

(76) Inventor: Robert J. Topper, Hatboro, PA (US)

Correspondence Address: RATNERPRESTIA, P O BOX 980, VALLEY FORGE, PA, 19482-0980, US

(21) Appl. No.: 10/361,251

(22) Filed: Feb. 10, 2003

(51) Int. Cl. H04N 5/213

(52) U.S. Cl. 348/624; 348/663

(57) ABSTRACT

A method, apparatus, and system for reducing chrominance artifacts in a luminance signal obtained from a composite NTSC television signal is disclosed. Chrominance artifacts are reduced by detecting chrominance artifacts in the luminance signal of a current line and a previous line, weighting the luminance signal of the current line and the luminance signal of the previous line based on the detected chrominance artifacts, and combining the weighted luminance signal of the current line and the weighted luminance signal of the previous line for use as the luminance signal for the current line. Reducing chrominance artifacts reduces the occurrence of “hanging-dots” displayed on a television monitor, which are due to incompletely canceled chrominance artifacts in the luminance signal.

### FIELD OF THE INVENTION

The present invention relates to the field of consumer electronics and, more particularly, to reducing chrominance artifacts in a luminance signal obtained from a composite NTSC television signal.

### BACKGROUND OF THE INVENTION

In a color television (TV) system (such as NTSC), the luminance and chrominance components (“luma” and “chroma,” respectively) of a composite color television signal are disposed within the video frequency spectrum in a frequency interleaved relation. The luma components are positioned at integral multiples of the horizontal line scanning frequency and the chroma components are positioned at odd multiples of one-half this frequency. In the NTSC system, the upper portion (i.e., about 2.1 to 4.2 MHz) of the video frequency spectrum (0 to 4.2 MHz) is shared by chroma components and high frequency luma components. The lower portion (below about 2.1 MHz) of the video frequency spectrum is occupied solely by luma components. The video frequency spectrum is located within a 6 MHz NTSC television channel and begins at 1.25 MHz within this channel. Thus, 2.1 MHz in the video frequency spectrum corresponds to 3.35 MHz in the 6 MHz NTSC television channel. Additionally, in accordance with the NTSC system, from horizontal-line to horizontal-line (“adjacent lines”), the luma components are in-phase with one another and the chroma components are 180 out-of-phase with one another.

Comb filters are frequently used to separate the luma and chroma components from one another. Comb filters operate on the premise that the composite video signals of adjacent lines are highly correlated. Since the luma components of adjacent lines are in-phase and the chroma components are out-of-phase, adding the composite signal for the previous line to the composite signal for the immediately preceding line yields the luma components of a current line. This effectively removes the chroma components, leaving only the luma components. Likewise, subtracting the composite signal of a previous line from the current line yields the chroma components of the current line. This effectively removes the luma components, leaving only the chroma components.

When the composite video signal from adjacent lines is not highly correlated, anomalies occur in the reproduced images. The anomalies result from imperfect cancellation of chroma in the luma signal. For example, if there is an abrupt change in the amplitude of chroma between adjacent lines, serrations will occur along the horizontal edges displayed in the image for a line combed filtered (hereinafter “combed”) signal. These serrations (called “hanging dots”) are due to incompletely cancelled chroma components (called “artifacts”) in the luma signal.

Various techniques have been developed to avoid hanging dots. Typically, these techniques examine a composite signal or a luma signal separated from the composite signal and use different filtering techniques based on this examination. Decision circuits examine these signals and actuate switches to select the appropriate technique. When the decision circuitry has difficulty deciding what to do, switching artifacts may be introduced to the display area of a television. Examples of these types of filters can be found in U.S. Pat. No. 4,814,863 to Topper et al. entitled DETECTION AND CONCEALING ARTIFACTS IN COMBED VIDEO SIGNALS and U.S. Pat. No. 4,179,705 to Faroudja entitled METHOD AND APPARATUS FOR SEPARATION OF CHROMINANCE AND LUMINANCE WITH ADAPTIVE COMB FILTERING IN A QUADRATURE MODULATED COLOR TELEVISION SYSTEM.

Accordingly, there is a need for methods, apparatus, and systems for separating chroma and luma components from a composite signal that have reduced chroma artifacts in the luma signal and address the limitation of the prior art. The present invention fulfills this need among others.

### SUMMARY

The present invention provides a luminance/chrominance (Y/C) separation method, apparatus, and system that satisfies the aforementioned need by detecting chroma artifacts in a luma signal separated from a composite NTSC television signal for a current line and a previous line. The detected chroma artifacts are then used to weight the luma signal for the current and previous lines. The weighted signals are then combined to form a replacement luma signal for the current line. The lines are weighted such that if the chroma artifacts in the current line are larger than the chroma artifacts in the previous line, the previous line will receive more weight in forming the replacement luma signal, and vice versa. Weighting the line with the smaller chroma artifact more heavily effectively removes the chroma artifact without the need of switching, thereby avoiding the generation of switching artifacts associated with such techniques. The detected chroma artifacts may additionally be used to weight the chroma signal for the current and previous lines. The weighted chroma signals are then combined to form a replacement chroma signal for the current line.

A method for reducing chroma artifacts in a luma signal of a current line in accordance with the present invention includes detecting chroma artifacts in the luma signal of a current line and a previous line, weighting the luma signal of the current line and the luma signal of the previous line based on the detected chroma artifacts, and combining the weighted luma signal of the current line and the weighted luma signal of the previous line for use as a replacement luma signal for the current line.

An apparatus for reducing chroma artifacts in a luma signal of a current line in accordance with the present invention includes a detection circuit which detects chroma artifacts in the luma signal of a current line and the luma signal of a previous line, a first weighting circuit which weights the luma signal of the current line and the luma signal of the previous line based on the detected chroma artifacts, and a first combiner which combines the weighted luma signal of the current line and the weighted luma signal of the previous line for use as a replacement luma signal for the current line.

A system for reducing chroma artifacts in a luma signal of a current line in accordance with the present invention includes means for detecting chroma artifacts in the luma signal of a current line and a previous line, first weighting means for weighting the luma signal of the current line and the luma signal of the previous line based on the detected chroma artifacts, and means for combining the weighted luma signal of the current line and the weighted luma signal of the previous line for use as a replacement luma signal for the current line.

### BRIEF DESCRIPTION OF THE DRAWINGS

The invention is best understood from the following detailed description when read in connection with the accompanying drawings. This emphasizes that according to common practice, the various features of the drawings are not drawn to scale. On the contrary, the dimensions of the various features are arbitrarily expanded or reduced for clarity. Included in the drawings are the following features:

FIG. 1 is a block diagram of a Y/C separation apparatus in accordance with the present invention; and

FIG. 2 is a block diagram of an artifact detector for use in the Y/C separation apparatus of FIG. 1.

### DETAILED DESCRIPTION OF THE INVENTION

In the DRAWINGS, the lines interconnecting various blocks represent either single conductor connections carrying analog signals or multi-conductor buses carrying multi-bit parallel binary digital signals. Those of skill in the TV signal processing art will appreciate that the invention may be practiced on either digital or analog representations of the composite video signal. For the purposes of the detailed description, however, it will be assumed herein that the composite video signal is a digital signal and that the composite video signal is in the NTSC format. Additionally, it will be assumed that the composite video signal is sampled at a sampling rate equal to four times the frequency of the color subcarrier (four times 3.58 MHz or approximately 14.3 MHz). Under these conditions there will be 4 sample intervals for one complete color-difference cycle and there will be a total of 910 samples per line. The four sample intervals may be represented by Y+I, Y+Q, Y−I, and Y−Q, where Y is luma, I is an in-phase component of chroma, and Q is a quadrature-phase component of chroma. Each sample of an interval includes Y and either I or Q, with I and Q alternating from sample to sample. One-half of one color-difference cycle includes one sample of I and one sample of Q, which together form a color-difference pair.

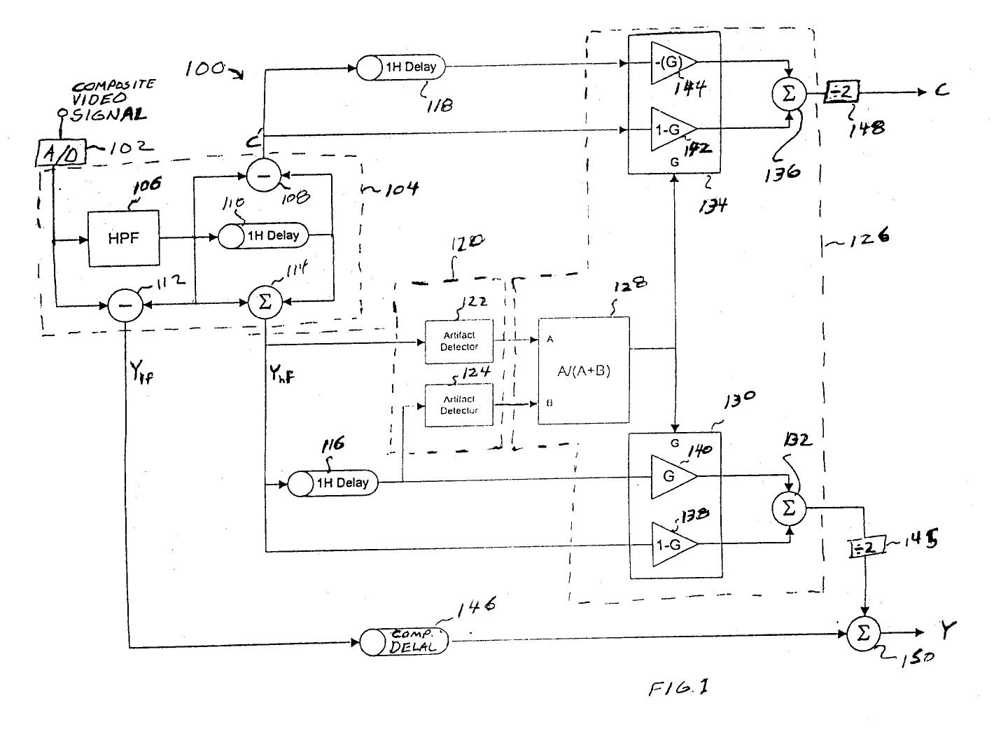

FIG. 1 depicts a luminance/chrominance (Y/C) separation apparatus 100 for separating a composite video signal into a chroma signal (C) and a luma signal (Y) in accordance with one embodiment of the present invention. The composite video signal is received from the output port of a video detector stage (not shown). The composite video signal is applied to an analog-to-digital (A/D) converter 102. The A/D converter 102 samples the incoming composite video signal at four times the color subcarrier frequency (4 fsc) and converts it into a digital signal.

The digital composite video signal at the output port of the A/D converter 102 is applied to a separator circuit 104 for separating the composite video signal into intermediate chroma and luma signals. In the illustrated embodiment, the separator circuit 104 separates the composite video signal into an intermediate chroma signal (C′), an intermediate low frequency luma signal (Ylf), and an intermediate high frequency luma signal (Yhf). The illustrated separator circuit 104 is a conventional comb filter including a high pass filter (HPF) 106, a first subtractor 108, a delay element 110, a second subtractor 112, and a summer 114.

Due to the overlap of luma and chroma components in the composite video signal at high frequencies, chroma artifacts may be present in Yhf after separation. Artifacts arise when the separator circuit 104 is unable to fully separate the composite signal into its luma and croma components. At frequencies where the luma and chroma components overlap, e.g., greater than 3 MHz in a 6 MHz NTSC television channel, the chroma components are typically much larger than the luma components. Thus, if present, the chroma artifacts overpower the luma components within Yhf, which appear as a pattern of dots on a television display.

The high pass filter (HPF) 106 is operative to pass frequencies above a predefined level. Preferably, the HPF 106 passes frequencies of the composite video signal in which luma and chroma components overlap (i.e., frequencies greater than approximately 3.0 MHz). The output signal of the HPF 106 is subtracted from the composite video signal by the first subtractor 108 to obtain Ylf. Since chroma components are not contained in the low frequency portion of the composite signal (i.e., frequencies less than approximately 3.0 MHz), the resultant Ylf contains low frequency luma components and is free of chroma artifacts. Accordingly, no further processing of Ylf is performed.

The high frequency signal passed by the HPF 106 contains all the chroma components and high frequency luma components. This high frequency signal is applied to the delay element 110. Preferably, the delay element 110 is a 1-H delay element, which delays the signal by one horizontal line scanning period to develop a delayed signal representing corresponding components from the previous horizontal line. The output signal of the delay element 100 is subtracted from the output signal of the HPF 106 by the second subtractor 112 to develop an intermediate chroma signal, C′. Additionally, the output signal of the delay element 100 is added to the output signal of the HPF 106 by summer 114 to develop Yhf. As described above, in the NTSC system, for adjacent horizontal lines, the luma components are in-phase and the chroma components are 180 degrees out-of-phase. In addition, typically, the luma components and the chroma components for adjacent horizontal lines do not vary substantially. Thus, adding two adjacent horizontal lines typically yields luma components at twice the amplitude of the luma components in a single line and subtracting one horizontal line from an adjacent horizontal line yields chroma components at twice the amplitude of the chroma components in a single line. If the chroma components change from line to line, artifacts of the chroma components may be found in Yhf.

In an exemplary embodiment, as described in detail below, to accommodate the presence of chroma artifacts in Yhf, current and previous lines of Yhf are weighted based on chroma artifacts in the current and previous lines for Yhf to produce a weighted Yhf. After weighting, Yhf is combined with Ylf to produce the luma signal Y. In addition, to compensate for the errors in the intermediate chroma signal, C′, caused by the changes in the chroma signal from line to line, current and previous lines of C′ are also weighted based on the chroma artifacts for Yhf to produce the chroma signal C.

Yhf is applied to a delay element 116 and C′ is also applied to a delay element 118. Preferably, the delay elements 116, 118 are 1-H delay elements, which delay Yhf and C′, respectively, by one horizontal line scanning period to develop delayed signals. The non-delayed signals represent the current lines and the delayed signals represent the previous lines for corresponding horizontal positions of the lines, i.e., pixels that are vertically adjacent

The Yhf signals for the current and previous lines are passed to an artifacts detector 120. The illustrated artifacts detector 120 includes a first artifact detector 122 and a second artifact detector 124. The first artifact detector 122 detects the presence of chroma artifacts in Yhf for the current line and the relative strength of these chroma artifacts. The second artifact detector 124 detects the presence of chroma artifacts in Yhf for the previous line and the relative strength of these chroma artifacts.

As described in detail below, in a preferred embodiment, the relative strength of the chroma artifacts in Yhf for the current and previous lines is used to weight Yhf for the current and previous lines to develop the high frequency portion of Y. Preferably, the relative strength of the chroma artifacts is also used to weight C′ for the current and previous lines to develop the chroma signal, C. In an alternative embodiment, C′ is not weighted and C is essentially C′.

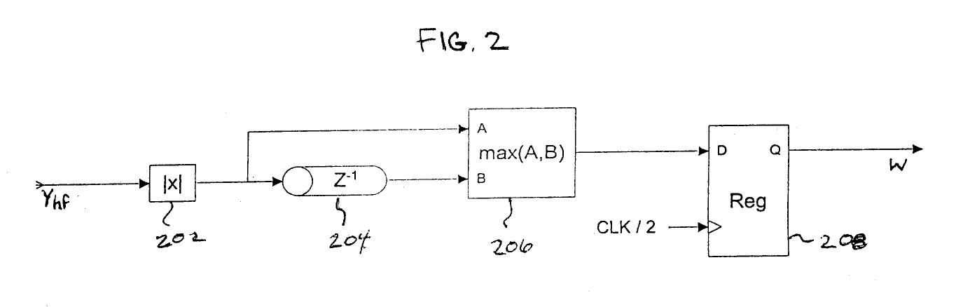

FIG. 2 depicts an exemplary artifact detection circuit 200 suitable for use as an artifact detector 122, 124 (FIG. 1) for processing Yhf of the current and previous lines, respectively, to develop signals representing the relative weights of the chroma artifacts within these lines. The illustrated artifact detection circuit 200 includes an absolute value circuit 202, a delay element 204, a maximum circuit 206, and a register 208. For descriptive purposes, the artifact detection circuit 200 is described in terms of detecting chroma artifacts in Yhf for the current line (i.e., as the artifact detector 122 of FIG. 1). The use of the artifact detection circuit 200 for detecting chroma artifacts in Yhf for the previous line will be readily apparent from the description for detecting chroma artifacts in Yhf for the current line.

The absolute value circuit 202 rectifies the individual samples of the color-difference cycles within Yhf since their arithmetic sign alternates from one-half color-difference cycle to the next. By rectifying the individual samples, the arithmetic sign can be ignored, leaving the magnitude of individual samples within the color-difference cycles.

The rectified individual samples are applied to the delay element 204. The delay element 204 introduces a one sample delay. Because the composite video signal is sampled at 4 fsc, the individual samples for a Yhf signal containing chroma artifacts of I and Q alternate between having an I artifact and a Q artifact. When an I artifacts is at the input port of the delay element 204, a Q artifact is at the output port, and vice versa.

The maximum circuit 206 processes adjacent rectified individual samples. Therefore, if chroma artifacts containing I and Q artifacts are present, the maximum circuit 206 processes a Q artifact of a sample and an I artifact of an adjacent sample. Because the samples are rectified by rectifier 202, the maximum circuit 206 can compare the magnitude of I and Q artifacts from adjacent individual samples within a single one-half color-difference cycle or spanning two one-half color-difference cycles. In the illustrated maximum circuit 206, the maximum circuit 206 produces a non-additive mix of the adjacent rectified individual samples at an output port. Thus, if the I artifact is larger than the Q artifact, the magnitude of the I artifact will be produced by the maximum circuit 206, and vice versa.

The register 208 processes the output signal of the maximum circuit 206. Preferably, the register 208 is clocked at one-half the individual sample rate. By clocking the register 208 at one-half the individual sample rate, the output signal produced by a color-difference pair (i.e., one I artifact and one Q artifact) is presented by the register 208 for two individual samples. Thus, one value is produced for both the individual samples of the color-difference pair. This value represents the relative weight, W, of the chroma artifacts within the line signal being processed.

Referring back to FIG. 1, the signals representing the relative weights of the chroma artifacts within Yhf of the current and previous lines are passed to a weighting circuit 126. The illustrated weighting circuit 126 includes a weight generator 128, a first weight block 130, a first summer 132, a second weight block 134, and a second summer 136. The first weight block 130 weights the current and previous lines of Yhf based on a weight determined by weight generator 128. The weighted current and previous lines of Yhf are then combined at the first summer 132 to produce the high frequency luma components of the signal Y, which is combined with the low frequency luma components of Y (i.e., Ylf) at summer 150 to produce the signal Y. The second weight block 134 weights the current and previous lines of C′ based on the weight determined by weight generator 128. The weighted current and previous lines of C′ are then combined at the second summer 136 to produce C. It will be apparent to those of skill in the art that in embodiments of the present invention where C′ is not weighted, the second weight block 134 can be eliminated.

The weight generator 128 in the illustrated embodiment generates the weight value, G, based on the relative weights of the chroma artifacts within the current and previous lines of Yhf as determined by the artifacts detector 120. In the illustrated embodiment, the weight generator generates a value representing the ratio of the relative weight of the chroma artifacts within the current line for Yhf to the sum of the relative weights of the chroma artifacts within the current and previous lines for Yhf. Thus, if the relative weight of artifacts in the current line is high (low) and the relative weight of artifacts in the previous line is low (high), G will approach one (zero). Accordingly, G will vary between 0 and 1 depending on the relative weights of the chroma artifacts on the two lines. In accordance with certain exemplary embodiments, if the relative weights of the chroma artifacts within Yhf for each of the current and previous lines are below a threshold valve, e.g., below two % of full scale video, G is set to zero. The weight generator 128 may be implemented using discrete components, integrated circuits, ASICs, or essentially any device capable of processing digital or analog signals.

The first weight block 130 in the illustrated embodiment includes a first amplifier 138 and a second amplifier 140. The first amplifier 138 amplifies the signal Yhf for the current line and the second amplifier 140 amplifies the signal Yhf for the previous line. In a preferred embodiment, the first amplifier 138 amplifies Yhf for the current line by 1-G and the second amplifier 140 amplifies Yhf for the previous line by G. Thus, if G is zero (one), Yhf for the current line is multiplied by one (zero) and Yhf for the previous line is multiplied by zero (one). Additionally, values of G between zero and one result in the amplification of Yhf for the current and previous lines by values between zero and one. Specifically, the previous line is amplified by G and the current line is amplified by 1-G. The first weight block 130 may be implemented using a conventional addressable memory block.

The second weight block 134 in the illustrated embodiment includes a first amplifier 142 and a second amplifier 144. The first amplifier 142 amplifies the signal C′ for the current line and the second amplifier 144 amplifies the signal C′ for the previous line. In an exemplary embodiment, the first amplifier 142 amplifies Yhf for the current line by 1-G and the second amplifier 144 amplifies Yhf for the previous line by -G. This is essentially identical to the processing performed by the first weight block 130, with the exception that G has a negative arithmetic sign, resulting in the inversion of the previous line.

Additional processing circuitry is provided to correct the magnitude of the signals and to ensure proper delay periods. This circuitry includes a first divider 145, a delay element 146, and a second divider 148. The first divider 145 divides Yhf by two to correct for a doubling of the magnitude of Yhf by the separator circuit 104. The delay element 146 delays Ylf to compensate for delay introduced to Yhf by the separator circuit 104 and the weighting circuit 126 such that the samples of Ylf coincide with corresponding samples of Yhf when combined at the summer 150. The second divider 148 divides the signal C by two to correct for a doubling of the magnitude of C′ by the separator circuit 104. The necessary components for correcting magnitude and delay periods are readily apparent to those of skill in the art of television signal processing.

In an exemplary use, the illustrated Y/C separation apparatus 100 operates in the following manner. The separator circuit 104 separates a composite signal into an intermediate chroma signal C′, a low frequency luma signal Ylf, and a high frequency luma signal Yhf. The high frequency luma signal Yhf may contain chroma artifacts that are not completely removed by the separator circuit 104. Yhf for the current line and Yhf for a previous line are supplied to an artifacts detector 120 that produces a weight value which is indicative of the relative level of chroma artifacts in Yhf. Yhf for current and previous lines are then weighted based on this weight value and the weighted lines are combined to form a replacement for the high frequency component of Y. Preferably, the ratio of the amplitudes from the artifact detectors 122, 124 are computed and used to weight the current and previous lines of Yhf such that lines having smaller detected values (i.e., less chroma artifacts) are weighted more heavily in creating the replacement for the high frequency component of Y for the current line.

The current and previous lines of Yhf for the illustrated embodiment are weighted as follows:

If the chroma artifacts in the current line and the previous line are essentially identical, the weight generator 128 produces a weight value, G, of one-half. If the weight value is one-half, Yhf for the previous line is amplified by one-half (i.e., G) and Yhf for the current line is amplified by one-half (i.e., 1-G). Thus, the previous and current lines each contribute equally to produce a replacement Yhf for the current line.

If the chroma artifacts detected in the current line are greater that the chroma artifacts detected in the previous line (a condition which may result in the appearance of “hanging-dots” on a television display), or vice versa, the weight generator 128 produces a weight value, G, proportional to the difference in the detected artifacts. If the weight value is one, Yhf for the previous line is amplified by one and Yhf for the current line is amplified by zero. Thus, the current line containing a high level of chroma artifacts is essentially discarded and the previous line is used to produce the replacement Yhf for the current line. If the weight value is zero, Yhf for the current line is amplified by one and Yhf for the previous line is amplified by zero. Thus, the previous line containing a high level of chroma artifacts is essentially discarded and the current line is used to produce the replacement Yhf for the current line. Values of G between one-half and one result in both previous and current lines contributing to the production of the replacement Yhf with the previous line being more heavily weighted than the current line. Likewise, values of G between zero and one-half result in both lines contributing to the replacement Yhf with the current line being more heavily weighted than the previous line.

If no chroma artifacts are detected in either the current line or the previous line, or the detected artifacts are below a predefined threshold value, the weight generator 128 produces a weight value, G, of zero. Thus, the current line is used to produce the replacement Yhf for the current line.

The current and previous lines of C′ for the illustrated embodiment are weighted essentially as described above for Yhf, with the exception that the previous line is inverted in addition to being amplified.

While a particular embodiment of the present invention has been shown and described in detail, adaptations and modifications will be apparent to one skilled in the art. Such adaptations and modifications of the invention may be made without departing from the scope thereof, as set forth in the following claims.

We claim:

1. A method for reducing chroma artifacts in a luma signal of a current line, the luma signal obtained from a composite NTSC television signal, said method comprising the steps of:
detecting chroma artifacts in the luma signal of a current line and a previous line;
weighting the luma signal of the current line and the luma signal of the previous line based on the detected chroma artifacts; and
combining the weighted luma signal of the current line and the weighted luma signal of the previous line for use as a replacement luma signal for the current line.

2. The method of claim 1, further comprising the steps of:
separating the luma signal into a first luma signal and a second luma signal, the first luma signal representing luma components below a predefined frequency and the second luma signal representing luma components above the predefined frequency, wherein said detecting, weighting, and combining steps are applied only to said second luma signal; and
combining said first luma signal with the combined weighted second luma signal.

3. The method of claim 2, further comprising the steps of:
weighting the chroma signal of the current line and weighting and inverting the chroma signal of the previous line based on the detected chroma artifacts; and
combining the weighted chroma signal of the current line and the inverted, weighted chroma signal of the previous line for use as a replacement chroma signal for the current line.

4. The method of claim 1, wherein the composite NTSC television signal is sampled digitally to produce two samples per one-half color-difference cycle and wherein said detecting step comprises at least the steps of:
processing the samples within one-half color-difference cycle for the current line and a corresponding one-half color-difference cycle for the previous line to generate weight values for weighting portions of the luma signal for the current line and the luma signal for the previous line corresponding to these one-half color-difference cycles.

5. The method of claim 4, wherein said processing step comprises at least the steps of:
selecting the samples within the one-half color-difference cycle having a larger magnitude for each of the current and previous lines; and
computing a ratio of the larger magnitude sample for the current line to a sum of the larger magnitude samples for the current and previous lines.

6. A method for separating a composite NTSC television signal into luma and chroma components, said method comprising the steps of:
separating the composite NTSC television signal into a chroma signal, a low frequency luma signal, and a high frequency luma signal, the high frequency luma signal including chroma artifacts;
detecting the chroma artifacts in the high frequency luma signal of a current line and a previous line;
weighting the chroma signal and the high frequency luma signal of the current line and the previous line based on the detected chroma artifacts;
combining the weighted chroma signal of the current line and the previous line for use as a replacement chroma signal for the current line and combining the weighted high frequency luma signal of the current line and the previous line for use as a replacement high frequency luma signal for the current line; and
combining the low frequency luma signal with the replacement high frequency luma signal;
wherein the high frequency luma signal of the current line and the previous line are weighted and combined such that the replacement high frequency luma signal has reduced chroma artifacts.

7. The method of claim 6, wherein the composite NTSC television signal is sampled to produce two samples per one-half color-difference cycle and wherein said detecting step comprises at least the steps of:
processing the samples within one-half color-difference cycle for the current line and a corresponding one-half color-difference cycle for the previous line to generate weight values for weighting portions of the luma signal for the current line and the luma signal for the previous line corresponding to these one-half color-difference cycles.

8. The method of claim 7, wherein said processing step comprises at least the steps of:
selecting the samples within the one-half color-difference cycle having a larger magnitude for each of the current and previous lines; and
computing a ratio of the larger magnitude sample interval for the current line to a sum of the larger magnitude samples for the current and previous lines.

9. An apparatus for reducing chroma artifacts in a luma signal separated from a composite NTSC television signal, said circuit comprising:
a detection circuit which detects chroma artifacts in the luma signal of a current line and the luma signal of a previous line;
a first weighting circuit which weights the luma signal of the current line and the luma signal of the previous line based on the detected chroma artifacts; and
a first combiner which combines the weighted luma signal of the current line and the weighted luma signal of the previous line for use as a replacement luma signal for the current line.

10. The apparatus of claim 9, further comprising:
a separator which separates the luma signal into a first luma signal and a second luma signal, the first luma signal representing luma components below a predefined frequency and the second luma signal representing luma components above the predefined frequency, wherein said detection circuit, first weighting circuit, and first combiner are applied only to said second luma signal; and
a second combiner which combines said first luma signal with the combined weighted second luma signal.

11. The apparatus of claim 10, further comprising:
a second weighting circuit which weights the chroma signal of the current line and the chroma signal of the previous line based on the detected chroma artifacts; and
a third combiner which combines the weighted signal of the current line and the weighted signal of the previous line for use as a replacement chroma signal for the current line.

12. A line-comb decoder for separating a composite signal into luma and chroma information comprising:
a comb filter having an input port for receiving a composite video signal, said comb filter configured to produce a chroma signal, a low frequency luma signal, and a high frequency luma signal, the high frequency luma signal including chroma artifacts;
a weighting circuit which weights the chroma signal and the high frequency luma signal for a current line and a previous line based on the chroma artifacts in the high frequency luma signal in the current line and the previous line such that the effect of the cross talk is reduced;
a first combiner which combines the weighted chroma signal of the current line and the previous line for use as a replacement chroma signal for the current line;
a second combiner which combines the weighted high frequency luma signal of the current line and the previous line for use as a replacement high frequency luma signal for the current line; and
a third combiner which combines the low frequency luma signal with the replacement high frequency luma signal;
wherein the high frequency luma signal of the current line and the previous line are weighted and combined such that the replacement high frequency luma signal has reduced chroma artifacts.

13. The decoder of claim 12, further comprising:
an artifact detector which detects relative weights of chroma artifacts within the high frequency luma signal of the current and previous lines.

14. The decoder of claim 13, wherein said weighting circuit comprises at least:
a weight generator which weights the current and previous lines based on the relative weights of the chroma artifacts detected by the artifact detector.

15. The decoder of claim 14, wherein said weight generator generates a ratio which weights the chroma signal and the high frequency luma signal for the current and previous lines, the ratio based on the relative weight of the chroma artifacts of the current line and a sum of the relative weights of the chroma artifacts of the current and previous lines.

16. A system for reducing chroma artifacts in a luma signal of a current line, the luma signal obtained from a composite NTSC television signal, said system comprising:
means for detecting chroma artifacts in the luma signal of a current line and a previous line;
first weighting means for weighting the luma signal of the current line and the luma signal of the previous line based on the detected chroma artifacts; and
means for combining the weighted luma signal of the current line and the weighted luma signal of the previous line for use as a replacement luma signal for the current line.

17. The system of claim 16, further comprising:
means for separating the luma signal into a first luma signal and a second luma signal, the first luma signal representing luma components below a predefined frequency and the second luma signal representing luma components above the predefined frequency, wherein said detecting, weighting, and combining steps are applied only to said second luma signal; and
means for combining said first luma signal with the combined weighted second luma signal.

18. The system of claim 17, further comprising:
means for weighting the chroma signal of the current line and means for weighting and inverting the chroma signal of the previous line based on the detected chroma artifacts; and
means for combining the weighted chroma signal of the current line and the inverted, weighted chroma signal of the previous line for use as a replacement chroma signal for the current line.

19. The system of claim 16, wherein the composite NTSC television signal is sampled digitally to produce two samples per one-half color-difference cycle and wherein said detecting means comprises at least:
means for processing the samples within the one-half color-difference cycle for a current line and a corresponding one-half color-difference cycle for a previous line to generate weight values for weighting portions of a luma signal for the current line and a respective luma signal for the previous line corresponding to the one-half color-difference cycles.

20. The system of claim 19, wherein said processing means comprises at least:
means for selecting the samples within the one-half color sample having a larger magnitude for each of the current and previous lines; and
means for computing a ratio of the larger magnitude sample for the current line to a sum of the larger magnitude samples for the current and previous lines.
